(19) United States
(12) Patent Application Publication
(10) Pub. No.: US 2024/0356828 A1
(43) Pub. Date: Oct. 24, 2024

(54) METHOD FOR MAINTAINING COMMUNICATION CONNECTION, ELECTRONIC DEVICE, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventors: Hua GUO, Dongguan (CN); Yifan ZHANG, Dongguan (CN); Fan LIU, Dongguan (CN)

(73) Assignee: GUANGDONG OPPO MOBILE TELECOMMUNICATIONS CORP., LTD., Dongguan (CN)

(21) Appl. No.: 18/761,236

(22) Filed: Jul. 1, 2024

Related U.S. Application Data
(63) Continuation of application No. PCT/CN2022/132724, filed on Nov. 18, 2022.

(30) Foreign Application Priority Data
Dec. 31, 2021 (CN) 202111670282.2

(51) Int. Cl. H04L 43/10; G06F 9/4401

(52) U.S. Cl. CPC H04L 43/10; G06F 9/4418

(57) ABSTRACT

A method and apparatus for maintaining a communication connection is applicable into an electronic device, the electronic device supports running of a first system and a second system, and the method includes: sending, by the first system, a heartbeat packet to an external device based on the heartbeat packet sending request, wherein the heartbeat packet is configured to maintain a communication connection between the electronic device and the external device; and receiving, by the first system, a heartbeat feedback packet sent by the external device. An electronic device, and a non-transitory computer-readable storage medium are further provided.

### CROSS REFERENCE TO RELATED APPLICATIONS

The present application is a continuation-application of International (PCT) Patent Application No. PCT/CN2022/132724, filed Nov. 18, 2022, which claims foreign priority to Chinese Patent Application No. 202111670282.2, filed Dec. 31, 2021, the disclosures of which are herein incorporated by reference in their entireties.

### TECHNICAL FIELD

The present disclosure relates to the field of electronic devices, and in particular to a method for maintaining communication connection, an electronic device, a non-transitory computer-readable storage medium.

### BACKGROUND

With the continuous development of science and technology, more and more electronic devices with different functions emerge at the historic moment, which brings many conveniences to a user's daily life.

In addition to being able to be used alone, the electronic device may further establish a communication connection with other external devices and interact with each other. For example, a smartwatch establishes a Bluetooth connection with a vehicle head unit in a vehicle a vehicle head unit in a vehicle, so as to achieve some specific interactions with the vehicle.

### SUMMARY OF THE PRESENT DISCLOSURE

According to a first aspect, some embodiments of the present disclosure provide a method for maintaining a communication connection applicable into an electronic device. The electronic device supports running of a first system and a second system. The method includes: sending, by the first system, a heartbeat packet to an external device based on the heartbeat packet sending request, wherein the heartbeat packet is configured to maintain a communication connection between the electronic device and the external device; and receiving, by the first system, a heartbeat feedback packet sent by the external device.

According to a second aspect, some embodiments of the present disclosure provide an electronic device. The electronic device includes a processor and a memory. The memory stores at least one instruction, and the at least one instruction is configured to be execute by the processor to perform the method for maintaining a communication connection described in the foregoing aspect.

According to a third aspect, some embodiments of the present disclosure provide a non-transitory computer-readable storage medium. The storage medium stores at least one instruction, and the at least one instruction is configured to be execute by a processor to perform the method for maintaining a communication connection described in the foregoing aspect.

### BRIEF DESCRIPTION OF THE DRAWINGS

FIG. 1 is a schematic diagram of a dual-core communication software framework corresponding to a second processor according to an embodiment of the present disclosure.

FIG. 2 is a schematic diagram of a dual-core communication software framework corresponding to a first processor according to an embodiment of the present disclosure.

FIG. 3 is a schematic diagram of an implementation environment according to an embodiment of the present disclosure.

FIG. 4 is a flowchart of a method for maintaining a communication connection according to an embodiment of the present disclosure.

FIG. 5 is a schematic diagram of a software framework of a smartwatch and a vehicle head unit according to an embodiment of the present disclosure.

FIG. 6 is a flowchart of a process of waking up a second system according to an embodiment of the present disclosure.

FIG. 7 is a flowchart of a process of waking up a second system according to another embodiment of the present disclosure.

FIG. 8 a sequence diagram of an interaction between a smartwatch and a vehicle head unit according to yet another embodiment of the present disclosure.

FIG. 9 a structural block diagram of an apparatus for maintaining communication connection according to another embodiment of the present disclosure.

FIG. 10 is a structural block diagram of an electronic device according to an embodiment of the present disclosure.

### BRIEF DESCRIPTION OF THE DRAWINGS

In order to make the purpose, technical solutions and advantages of the present disclosure clearer, the present disclosure will be further described in detail below with reference to the accompanying drawings.

In the present disclosure, the term “multiple” or “a plurality of” means two or more. The term “and/or” may illustrate an association relationship of associated objects, indicating that three relationships can exist. For example, A and/or B may indicate: the existence of A alone, the existence of both A and B, and the existence of B alone. In addition, the character “/” may generally indicate an “or” relationship between the former object and latter object.

In the related art, an electronic device is configured with a single processor that processes, by running an operating system on the processor, all system events generated during running of the device. Therefore, the processor needs to have a powerful data processing capability and remain in a working state during the running of the device. However, the electronic device only needs to realize some functions that require low processing performance in most cases in daily usc. Taking a smartwatch or a smart wristband as examples, the smartwatch or the smart wristband only needs to perform a time display and message prompt in most cases. Therefore, the processor remaining in the working state for a long time does not improve the performance of the electronic device, but increases the power consumption of the device, resulting in a shorter battery life of the electronic device (especially on a wearable device with small battery capacity).

In order to reduce the power consumption of the electronic device while ensuring the performance of the electronic device, in a possible embodiment, the electronic device is configured with at least a first processor and a second processor that have different processing performances and power consumption. The first processor is configured to run the first system, and the second processor is configured to run the second system (namely, a dual-core dual system). A set of system switching mechanisms is designed for the dual-core dual-system.

During the running of the electronic device, the first system is run by a processor with low-power consumption to process an event that requires low processing performance, and a processor with high-power consumption remains in a sleep state (correspondingly, the second system ran by the processor with high-power consumption is in the sleep state), thus reducing power consumption of the electronic device while realizing a basic function of the electronic device. When an event that require high processing performance occurs (for example, when an application program is started), the processor with high-power consumption is woken up and the second system is switched to process the event, so as to ensure that a triggered event can be responded to and processed in time to satisfy a performance requirement of the electronic device.

During the running of the electronic device, some applications running on a high power consumption system need to maintain a communication connection with other devices. In some embodiments, the vehicle application running on the high power consumption system needs to maintain a Bluetooth connection with the vehicle device, so as to achieve a specific function (such as vehicle unlocking, vehicle locking, and checking a vehicle state). In the scenario, the high power consumption system needs to keep in a wake-up state for a long time, and a process of the vehicle application needs to keep in a camp-on state for a long time. However, the high power consumption system is in the wake-up state for a long time, and the process of the vehicle application program is in the camp-on state for a long time, which may cause the power consumption of the electronic device to increase.

In some embodiments of the present disclosure, when the second system needs to maintain the communication connection with an external device, the second system sends a heartbeat packet sending request to the first system. The first system sends a heartbeat packet to the external device based on the heartbeat packet sending request, and receives a heartbeat feedback packet sent by the external device. When the second system is in a sleep state, or a process of an application program in the second system that needs to maintain data communication with the external device ends, a normal sending of the heartbeat packet is maintained between the electronic device and the external device, so as to ensure the availability of a communication connection between subsequent devices. In addition, when the second system is a high power consumption system, and the first system is a low power consumption system, the low power consumption system maintains the communication connection, and the second system may enter the sleep state, so as to facilitate reducing the power consumption of the electronic device and extending the battery life of electronic device.

In some embodiments of the present disclosure, the first processor and the second processor work asynchronously, and the first system and the second system need to realize system communication (or referred to as dual-core communication). In a possible application scenario, the first system is a real-time operating system (RTOS) run by a micro control unit (MCU), and the second system is an Android operating system run by a central processing unit (CPU).

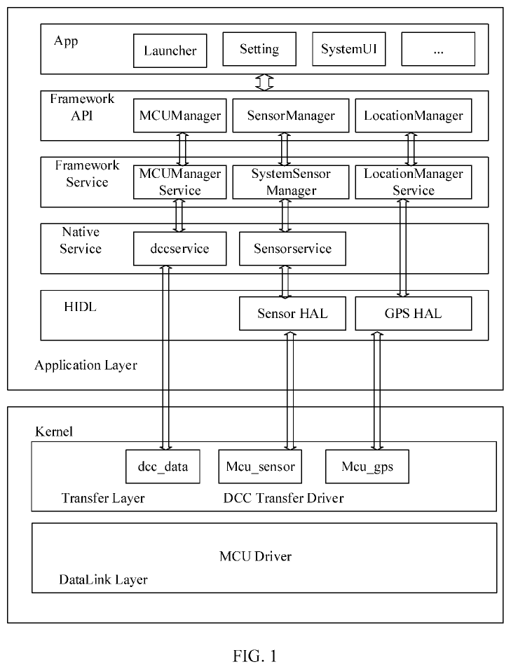

As illustrated in FIG. 1, FIG. 1 illustrates a dual-core communication software framework of the Android operating system according to some embodiments of the present disclosure. The dual-core communication software framework adheres to the design principles of “low coupling, high reliability, and high multiplexing”, and includes developments of a kernel module, a hardware abstraction layer interface definition language (HIDL) module, a native service module, a framework service module, a framework application programming interface (API) module, and an application (APP) module.

The APP module includes functional modules such as a launcher (desktop launcher), a set-ting, a system user interface (UI), or the like. The framework API module includes management modules such as an MCU manager, a sensor manager, a location manager, or the like. The frame-work service module includes service modules such as an MCU manager service, a system sensor manager, a location manager service, or the like. The native service module includes service modules such as a data call control service (dec service), a sensor service, or the like. The HIDL module includes modules such as a sensor hardware abstraction layer (HAL), a global positioning system (GPS) HAL, or the like. The kernel module includes DCC transfer drivers such as dcc_data, Mcu_sensor, Mcu_gps, or the like.

A transport layer serves as an interface layer connecting an upper layer and a lower layer in a dual-core communication software framework. The transport layer is configured to shield a transport detail of communication at the lower layer (a data link layer) of a system from an application layer and provide a service channel for an application scenario. The application layer, as a main provider of services, is configured to respond to human-computer interaction, transmit data generated during human-computer interaction through a transmission layer, and respond to an external data request.

The RTOS is designed under the principle of equivalence. Taking the electronic device as a smartwatch as an example, as illustrated in FIG. 2, FIG. 2 illustrates a dual-core communication software framework of the RTOS according to some embodiments of the present disclosure.

The dual-core communication software framework of the RTOS is divided into an application layer, a service layer, a framework layer, a HAL, and a platform layer.

The application layer includes application modules such as a watch face, a daily tracker, a message center, voice around Apps, health Apps, settings, or the like. The service layer includes service modules such as a sport & health task, a system manager task, an activity management service (AMS), an audio service, a log service, an Odette file transfer protocol (OFTP) service, a Bluetooth (BT) service, a delegate service, a remote procedure call (RPC) service, a sensor service, a storage service, or the like. The framework layer includes framework modules such as a message pub, a UI framework, a graphics 2D (G2D) Engine, an audio middleware, a preference, a file system, algorithms, an AsycEvent, or the like. The HAL includes hardware abstraction modules such as a screen/touch panel (TP), sensors, keypad, motor, or the like. The platform layer includes a board support packet (BSP) and a low-level driver, where the BSP includes a screen/TP, a codec, sensors, a flash, a pseudo static random access memory (PSRAM), or the like; and the low-level driver includes a universal asynchronous receiver/transmitter (Uart), an analog-to-digital converter (ADC), a general purpose input/output (GPIO), a serial peripheral interface (SPI), an inter-integrated circuit (I2C), an input/output system (IOS), a pulse-code modulation (PCM), an inter-IC sound (I2S), and a hardware (HW) timer.

It should be noted that the foregoing dual-core communication software framework is only used for exemplary description, and a person skilled in the art may add, delete or modify the fore-going framework according to actual requirements. The present disclosure does not limit a specific structure of the dual-core communication software framework.

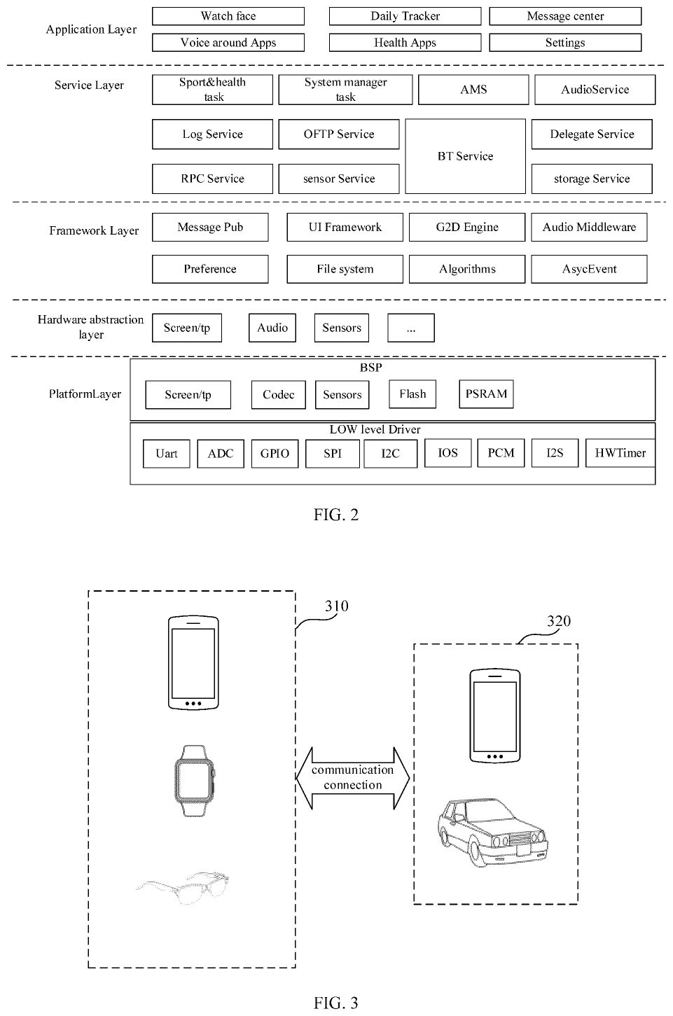

As illustrated in FIG. 3, FIG. 3 illustrates a schematic diagram of an implementation environment according to an embodiment of the present disclosure. In the embodiment, the implementation environment includes an electronic device 310 and an external device 320.

The electronic device 310 supports running of a first system and a second system (with different power consumption and different processing performance). The electronic device 310 may be a device with smaller battery capacity and higher requirement for the battery life, such as a smart phone, a tablet, a wearable device, etc. As illustrated in FIG. 3, the electronic device 310, which is the smart phone, the smartwatch, and smart glasses, is taken as an example for exemplary description.

In some embodiments of the present disclosure, the electronic device 310 is arranged with a communication assembly. The electronic device 310 may establish a communication connection with other devices and perform data communication through the communication assembly. In some embodiments, the communication assembly may be a Bluetooth assembly, a Wi-Fi assembly, etc., which is not limited herein.

In some embodiments, a processor (or a processor core) running the first system and the second system is mounted with the communication assembly (a dual communication assembly), and each of the first system and the second system may perform data communication through a corresponding communication assembly thereof. In some embodiments, the processor (or the processor core) running a low power consumption system is mounted with the communication assembly (a single communication assembly). The low power consumption system keeps a wake-up state during the running of the electronic device, and each system performs data communication through the corresponding communication assembly of the low power consumption system.

The external device 320 is a device establishing a communication connection with the electronic device 310. As illustrated in FIG. 3, the external device 320, which is the smart phone and a vehicle head unit in a vehicle, is taken as an example for exemplary description. In some embodiments of the present disclosure, after establishing a communication connection with the external device 320, the electronic device 310 maintains the communication connection through a heartbeat packet. The electronic device 310 sends the heartbeat packet through the first system, and the first system may be a low power consumption system.

In a possible application scenario, the electronic device 310 is the smartwatch, and the external device 320 is the vehicle head unit. After the smartwatch establishes a Bluetooth connection with the vehicle head unit, it is necessary to periodically send the heartbeat packet to the vehicle head unit through the Bluetooth connection. The heartbeat packet is sent by the first system based on a parameter carried in a heartbeat packet sending request sent by the second system. After receiving the heartbeat packet, the vehicle head unit sends the heartbeat feedback packet including a vehicle state and other information to the smartwatch. Correspondingly, the first system receives and processes the heartbeat feedback packet, and determines whether it is necessary to send the processed heartbeat feedback packet to the second system for further processing based on a processing result.

In the following embodiments, the method for maintaining a communication connection is performed by the electronic device 310 as an example.

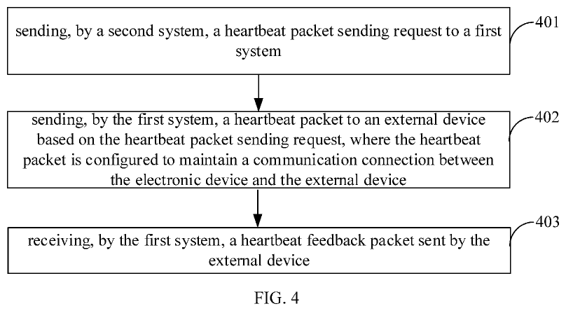

As illustrated in FIG. 4, FIG. 4 is a flowchart of a method for maintaining a communication connection according to an embodiment of the present disclosure. In the embodiment, for example, the method is applicable into an electronic device that supports running of a first system and a second system. The method may include the following operations.

At block 401, the second system sends a heartbeat packet sending request to the first system.

A communication connection is established between the electronic device and an external device. The electronic device performs a data interaction with the external device through the communication connection. In order to maintain the communication connection, the heartbeat packet needs to be sent between the electronic device and the external device at a certain time interval.

In a possible embodiment, the electronic device is arranged with a first processor and a second processor. Processing performance of the first processor is lower than that of the second processor (both processing capacity and processing speed of the first processor are lower than those of the second processor), and power consumption of the first processor is lower than that of the second processor. Correspondingly, the second system (run by the second processor) is capable of processing an event processed by the first system (run by the first processor), and the first system may not be able to process the event processed by the second system.

In another possible embodiment, the electronic device may be arranged with a single processor. The first system and the second system are respectively run by different cores of the processor. The processing performance of a core running the second system is higher than processing performance of a core running the first system.

Taking the electronic device as the smartwatch as an example, the first processor is an MCU, the second processor is a CPU, the first system is a RTOS, and the second system is an Android system. Correspondingly, an event that may be processed by the first system includes scenarios requiring low processing performance or weak interaction scenarios, such as watch face display, watch-face interface switch, notification-and-message display, etc. An event that may be processed by the second system includes scenarios requiring high processing performance or strong interaction scenarios, such as incoming calls answering, application starting, watch-face editing, function setting, etc.

In a possible embodiment, a working mode of the electronic device may include a performance mode, a hybrid mode, or a low-power mode. In the performance mode, the second processor and the first processor both remain in the wake-up state (correspondingly, both the first system and the second system are in the wake-up state). In the low-power mode, only the first processor remains in the wake-up state, and the second processor is in an off state (that is, the first system is in the wake-up state, and the second system is in the off state). In the hybrid mode, the second processor is in a standby state and may switch between the sleep state and the wake-up state when the first system processes an event (that is, when the first system is in the wake-up state, the second system may be in the wake-up state or in the sleep state).

In some embodiments, in the wake-up state, system-related data is cached in a memory such as a random access memory (RAM) and can be run at any time. In the sleep state, most hardware modules of the processor are turned off, system-related data is stored in a hard disk such as a read-only memory (ROM), and the system-related data is written into the memory from the hard disk when the sleep state is switched to the wake-up state. Since operating power consumption of the first system is lower than that of the second system, the first system is in the wake-up state for a long time during the running of electronic device, while the second system is switched from the sleep state to the wake-up state only when it is necessary to handle a specific event, so as to extend the battery life of the device. In some embodiments of the present disclosure, when the second system or the target application run by the second system needs to maintain the communication connection by sending the heartbeat packet, the second system sends the heartbeat packet sending request to the first system, and the first system is requested to replace the second system or the target application to send the heartbeat packet when the first system is in the wake-up state. In this way, it may be possible to ensure that the communication connection between the electronic device and the external device may still be maintained when the second system is in the sleep state, or when a target application process run by the second system ends. The heartbeat packet sending request may be sent in the mode of dual core communication.

In some embodiments, the heartbeat packet sending request includes a heartbeat packet parameter required when sending the heartbeat packet. The heartbeat packet parameter may include a heartbeat period, a heartbeat packet data format, etc. Alternatively, the heartbeat packet sending request includes the heartbeat packet.

In a possible embodiment, the first system is arranged with a heartbeat packet application. The heartbeat packet application is configured to generate and send the heartbeat packet, and the heartbeat packet sending request is sent to the heartbeat packet application.

In an exemplary embodiment, the smartwatch supports running of an RTOS and an Android system. When a first vehicle-controlled application in the Android system needs to maintain a Bluetooth communication with a second vehicle-controlled application in the vehicle head unit (performing the exchange of device states), the first vehicle-controlled application sends the heart-beat packet sending request to a heartbeat packet application in the RTOS.

At block 402, the first system sends a heartbeat packet to an external device based on the heartbeat packet sending request. The heartbeat packet is configured to maintain a communication connection between the electronic device and the external device.

In a possible implementation mode, after receiving the heartbeat packet sending request, the first system sends the heartbeat packet to the external device according to a method of sending heartbeat packets indicated by the heartbeat packet sending request. In a subsequent process, even if the second system enters the sleep state or the target application process ends, the first system may continue to transmit heartbeat packet data and maintain the communication connection between the electronic device and the external device.

Based on the heartbeat packet sending request, the first system sends the heartbeat packet to the external device according to the heartbeat period. In some embodiments, the heartbeat period is provided by the second system. Alternatively, the heartbeat period is a default period. In a possible embodiment, the heartbeat packet sending request includes the heartbeat period. After receiving the heartbeat packet sending request, the first system sets a periodic task based on the heartbeat period, and sends the heartbeat packet to the external device according to the heartbeat period. In some embodiments, when the heartbeat period is 100 ms, the first system sends the heartbeat packet to the external device every 100 ms.

In some embodiments, the first system generates the heartbeat packet through the heartbeat packet application, and invokes the communication assembly to send the heartbeat packet to the external device.

In some embodiments, the communication assembly of the electronic device is mounted to a processor or a processor core running the first system. Therefore, when the first system is in the wake-up state, the communication assembly may be invoked to send the heartbeat packet to the external device.

In an exemplary embodiment, the heartbeat packet application in the RTOS generates the heartbeat packet based on the heartbeat packet sending request, and invokes a Bluetooth assembly to send the heartbeat packet to the vehicle head unit through the Bluetooth connection.

At block 403, the first system receives a heartbeat feedback packet sent by the external device.

In order to make the electronic device know a state of the external device and prevent the electronic device from actively disconnecting the communication connection, the external device needs to feedback the heartbeat feedback packet to the electronic device through the communication connection after receiving the heartbeat packet. Therefore, the first system is not only responsible for sending the heartbeat packet, but also responsible for receiving the heartbeat feedback packet. In some embodiments, the heartbeat feedback packet includes the state of the external device, and a frequency at which the external device sends the heartbeat feedback packet may be the same as or different from a frequency at which the electronic device sends the heartbeat packet.

In some embodiments, the heartbeat packet sending request further includes a feedback packet processing strategy. The first system processes the heartbeat packet according to the feedback packet processing strategy.

Since the first system cannot fully replace functions of the second system, the second system is still required for performing event handling in some scenarios. In some embodiments, the heartbeat packet sending request further includes a system switching strategy. The system switching strategy is configured to instruct to switch from the first system to the second system for per-forming event handling.

Of course, the above feedback packet processing strategy and the system switching strategy may also be independently of the heartbeat packet sending request, which is not limited herein.

In an exemplary embodiment, after receiving the heartbeat packet through the Bluetooth connection, the vehicle head unit generates the heartbeat feedback packet including a vehicle state through the second vehicle-controlled application, and sends the heartbeat feedback packet to the smartwatch through the Bluetooth connection. After receiving the heartbeat feedback packet, the smartwatch sends the heartbeat feedback packet to a heartbeat application in the RTOS for processing.

In a possible embodiment, when the heartbeat feedback packet sent by the external device is not received in a second duration, the first system disconnects the communication connection, such that it may be possible to reduce unnecessary power consumption caused by the external device continuing to maintain the communication connection when the external device is offline. The second duration is provided by the second system, and the second duration may be contained in the heartbeat packet sending request, or may be independent of the heartbeat packet sending request. In some embodiments, the second duration is 500 ms.

In some embodiments, the first system is arranged with a timer based on the second duration. If the heartbeat feedback packet is not received in a timer duration, the first system disconnects the communication connection. If a heartbeat feedback packet is received in the timer duration, the first system may reset the timer.

In some embodiments, before disconnecting the communication connection, the first system sends a connection/disconnection inquiry message to the second system. After receiving a connection/disconnection reply sent by the second system, the communication connection is disconnected.

In conclusion, in some embodiments of the present disclosure, for the electronic device supporting dual systems, when it is necessary to maintain the communication connection with the external device, the second system sends the heartbeat packet sending request to the first system. The first system sends the heartbeat packet to the external device based on the heartbeat packet sending request, and receives the heartbeat feedback packet sent by the external device. Even if the second system enters the sleep state, or the process of an application program in the second system that needs to maintain data communication with the external device ends, a normal sending of the heartbeat packet is maintained between the electronic device and the external device, so as to prevent the communication connection between the electronic device and the external device from being disconnected, thereby facilitating improving the stability and availability of the communication connection between devices.

In addition, when the operating power consumption of the first system is lower than that of the second system, the first system sends the heartbeat packet to maintain the communication connection, and the second system does not need to remain in the wake-up state for a long time. Therefore, it may be possible to reduce the device power consumption of the electronic device, thereby increasing the battery lifetime of the device.

In some embodiments, the method for maintaining a communication connection further include: waking up, by the first system, the second system in a case where a wake-up condition is met and the second system is in a sleep state, wherein the wake-up condition is provided by the second system; sending, by the first system, the heartbeat feedback packet to the second system in response to the second system being switched to a wake-up state; processing, by the second system, the heartbeat feedback packet.

In some embodiments, the wake-up condition is a periodic wake-up condition. The waking up, by the first system, the second system in a case where a wake-up condition is met and the second system is in a sleep state, includes: waking up, by the first system, the second system in a case where a wake-up time point is reached and the second system is in the sleep state, wherein a time interval between adjacent wake-up time points is defined as a first duration.

In some embodiments, the method for maintaining a communication connection further includes: updating, by the second system, the periodic wake-up condition, in response to a processing result of the heartbeat feedback packet meeting a condition for updating duration. In some embodiments, the periodic wake-up condition is contained in the heartbeat packet sending request; or the periodic wake-up condition is sent independently of the heartbeat packet sending request.

In some embodiments, the wake-up condition is a data wake-up condition, the waking up, by the first system, the second system in a case where a wake-up condition is met and the second system is in a sleep state, includes: parsing, by the first system, the heartbeat feedback packet and obtaining feedback data; and waking up, by the first system, the second system in a case where the feedback data includes target data and the second system is in the sleep state.

In some embodiments, the method for maintaining a communication connection further includes: updating, by the second system, the data wake-up condition and switching from the wake-up state to the sleep state in response to processing of the heartbeat feedback packet being completed.

In some embodiments, the data wake-up condition is contained in the heartbeat packet sending request; or the data wake-up condition is sent independently of the heartbeat packet sending request.

In some embodiments, the sending, by the first system, a heartbeat packet to an external device based on the heartbeat packet sending request, includes: based on the heartbeat packet sending request, sending, by the first system, the heartbeat packet to the external device according to a heartbeat period.

In some embodiments, the method for maintaining a communication connection further includes: disconnecting, by the first system, the communication connection in a case where the heartbeat feedback packet sent by the external device is not received in a second duration, wherein the second duration is provided by the second system.

In some embodiments, operating power consumption of the first system is lower than that of the second system.

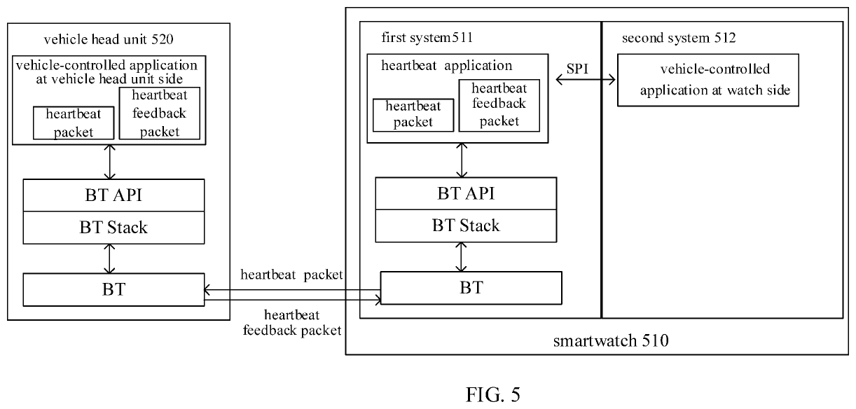

With reference to the above embodiments, in an exemplary example, when the smartwatch communicates with the vehicle head unit through the Bluetooth (BT) connection, a software frame-work of the smartwatch and the vehicle head unit is illustrated in FIG. 5.

A smartwatch 510 supports a first system 511 and a second system 512. The second system 512 runs a vehicle-controlled application at the watch side, and the first system 511 runs a heartbeat application. A vehicle-controlled application at the vehicle head unit side is running on a vehicle head unit 520.

The first system 511 communicates with the vehicle head unit 520 through the Bluetooth (BT) connection (each of the first system 511 and the vehicle head unit 520 is arranged with a BT stack and a BT API, while the second system 512 is not arranged with the BT Stack and the BT API), and the first system 511 communicates with the second system 512 through a physical SPI. When it is necessary to maintain the Bluetooth connection between the vehicle-controlled application at the watch side and the vehicle-controlled application at the vehicle head unit side, the vehicle-controlled application at the watch side of the second system 512 sends the heartbeat packet sending request to the heartbeat application of the first system 511 through the SPI. The heartbeat application generates a heartbeat packet based on a parameter in the heartbeat packet sending request, and sends the heartbeat packet to the vehicle head unit 520 through the Bluetooth. After receiving the heartbeat packet through the Bluetooth, the vehicle head unit 520 may send the heartbeat packet to the vehicle-controlled application at the vehicle head unit side for processing.

The vehicle-controlled application at the vehicle head unit side generates a heartbeat feedback packet based on the heartbeat packet, and sends the heartbeat feedback packet to the smartwatch 510 through the Bluetooth. After receiving the heartbeat feedback packet, the smartwatch 510 sends the heartbeat feedback packet to the heartbeat application for processing.

In a possible embodiment, after sending the heartbeat packet sending request, the second system enters the sleep state (in a case where there are no other events that need to be processed by the second system). When the second system is in the sleep state, the first system processes the heartbeat feedback packet sent by the external device. In order to prevent the second system from remaining in the sleep state for a long time and being unable to process the heartbeat feedback packet, the first system needs to wake up the second system based on a wake-up condition. The wake-up condition is a condition that is required to be met for the first system to wake up the second system. In some embodiments, the wake-up condition is contained in the heartbeat packet sending request. Alternatively, the wake-up condition is sent independently of the heartbeat packet sending request.

In some embodiments, when the wake-up condition is met and the second system is in the sleep state, the first system wakes up the second system. When the second system is switched to the wake-up state, the first system sends the heartbeat feedback packet to the second system, and the second system processes the heartbeat feedback packet.

In some embodiments, the wake-up condition may include at least one of: a periodic wake-up condition and a data wake-up condition. Under the periodic wake-up condition, the first system wakes up the second system in the sleep state every certain duration. Under the data wake-up condition, the first system wakes up the second system in the sleep state when specific data is contained in the heartbeat feedback packet. Exemplary embodiments may be used to illustrate the above two wake-up mechanisms as below.

As illustrated in FIG. 6, FIG. 6 illustrates a flowchart of a process of waking up a second system according to an embodiment of the present disclosure. The method may include the following operation.

At block 601, when a wake-up time point is reached and the second system is in the sleep state, the first system wakes up the second system. A time interval between adjacent wake-up time points is defined as a first duration.

In a possible embodiment, the first system is arranged with a timer. A timer duration of the timer is the first duration, and the first duration is provided by the second system. During a process of sending heartbeat packet, the first system determines that the wake-up time point is reached and resets the timer when the timer duration is reached.

In some embodiments, the first duration may be 30 seconds, 1 minute, 5 minutes, etc., which is not limited herein.

In some embodiments, the first duration is contained in the heartbeat packet sending request, or the first duration is sent independently of the heartbeat packet sending request.

In some embodiments, when the wake-up time point is reached, the first system detects whether the second system is in the wake-up state. If the second system is in the wake-up state (the second system may be currently processing other events), perform the block 602. If the second system is in the sleep state, wake up the second system.

In some embodiments, the first system wakes up the second system by generating an interrupt.

At block 602, when the second system is switched to the wake-up state, the first system sends a heartbeat feedback packet to the second system.

In a possible embodiment, when the second system is in the wake-up state, the heartbeat feedback packet continues to be received by the first system, but the first system no longer processes the heartbeat feedback packet. Instead, the first system directly forwards the heartbeat feedback packet to the second system. The first system may forward the heartbeat feedback packet to the second system through the SPI, which is not limited herein.

It should be noted that when the second system is in the wake-up state, the first system continues to send the heartbeat packet based on the heartbeat packet sending request, so as to maintain the communication connection.

At block 603, the second system processes the heartbeat feedback packet.

The second system processes the heartbeat feedback packet sent by the first system. In a possible embodiment, the second system displays a processing result (the second system obtaining a screen control authority). Alternatively, the second system performs muting process on the heart-beat feedback packet in a background and does not display the processing result. Alternatively, the second system performs muting process on the heartbeat feedback packet in the background and sends the processing result to the first system for displaying (the first system has the screen control authority).

In an exemplary embodiment, the external device is the vehicle head unit, and the electronic device is the smartwatch. After receiving the heartbeat packet sent by the smartwatch, the vehicle head unit adds vehicle air conditioning temperature to the heartbeat feedback packet. The first system of the smartwatch wakes up the second system every 30 seconds, such that the second system may display the vehicle air conditioning temperature in the heartbeat feedback packet.

In a possible embodiment, after the second system is woken up by the first system, the second system is switched from the wake-up state to the sleep state again after a duration for which the second system remains the wake-up state reaches a preset duration, so as to reduce the increasing power consumption that results from the system being in the wake-up state for a long time. The preset duration may be defined by the second system. For example, the preset duration is 10 seconds.

In some embodiments, when the second system is in the wake-up state, the second system determines whether it is necessary to update the first duration scheduled wake-up (i.e., update the periodic wake-up condition) according to the processing result during a process of processing the heartbeat feedback packet.

In some embodiments, a condition for updating duration includes a condition for extending duration and a condition for reducing duration. The condition for extending duration is a condition that is required to be met to extend the first duration. The condition for reducing duration is a condition that is required to be met to reduce the first duration.

In some embodiments, in a case where the second system is in the wake-up state, when the second system detects that first data is contained in the heartbeat feedback packet, it is determined that the condition for reducing duration is met. When the second system detects that second data is contained in the heartbeat feedback packet, it is determined that the condition for extending duration is met.

In an exemplary embodiment, when it is detected that a value of an identification bit corresponding to the vehicle state in the heartbeat feedback packet is 1 (indicating that the vehicle is in a starting state), the second system determines that the condition for reducing duration is met (that is, it is necessary to reduce the first duration, so as to increase a wake-up frequency). When it is detected that a value of the identification bit corresponding to the vehicle state in the heartbeat feedback packet is 0 (indicating that the vehicle is in non-started state), the second system deter-mines that the condition for extending duration is met (that is, it is necessary to extend the first duration, so as to reduce the wake-up frequency, thereby reducing the power consumption).

In some embodiments, when the periodic wake-up condition (the first duration) is contained in the heartbeat packet sending request, the second system sends a new heartbeat packet sending request to the first system, and is switched from the wake-up state to the sleep state in a case where the processing result of the heartbeat feedback packet meets the condition for updating duration. A periodic wake-up condition in the new heartbeat packet sending request is different from a periodic wake-up condition in a previous heartbeat packet sending request. Correspondingly, the first system sends the heartbeat packet to the external device based on the new heartbeat packet sending request, and wakes up the second system according to a new period.

In some embodiments, when the condition for extending duration is met, a first duration contained in the new heartbeat packet sending request is greater than a first duration contained in the previous heartbeat packet sending request. When the condition for reducing duration is met, the first duration contained in the new heartbeat packet sending request is less than the first duration contained in the previous heartbeat packet sending request.

In an exemplary embodiment, a first duration contained in a first heartbeat packet sending request is 30 seconds, and the first system wakes up the second system every 30 seconds. After the second system is woken up, the second system determines that the d the condition for reducing duration is met when it is detected that the value of the identification bit corresponding to the vehicle state in the heartbeat feedback packet is 1 (indicating that the vehicle is in a starting state), so as to send a second heartbeat packet sending request to the first system. A first duration contained in the second heartbeat packet sending request is 10 seconds. The first system subsequently wakes up the second system every 10 seconds.

In some embodiments, when the processing result of the heartbeat feedback packet does not meet the condition for updating condition, the second system is switched from the wake-up state to the sleep state after completing the processing of the heartbeat feedback packet. Since no new request is received, the first system continues to send the heartbeat packet to the external device based on the previous heartbeat packet sending request, and wakes up the second system according to the original period.

In some embodiments, when the processing result of the heartbeat feedback packet meets the condition for updating duration, the second system may extend the duration for which the second system remains the wake-up state, so as to process more heartbeat feedback packets in time. In some embodiments, the duration for which the second system remains the wake-up state may extend from 10 seconds to 20 seconds.

In the embodiment, the second system determines whether it is necessary to update the periodic wake-up condition based on the processing result of the heartbeat feedback packet. There-fore, not only it may be possible to reduce the power consumption of the electronic device (ex-tending a wake-up period), but also it may be possible to ensure that the heartbeat feedback packet is processed in time (reducing the wake-up period).

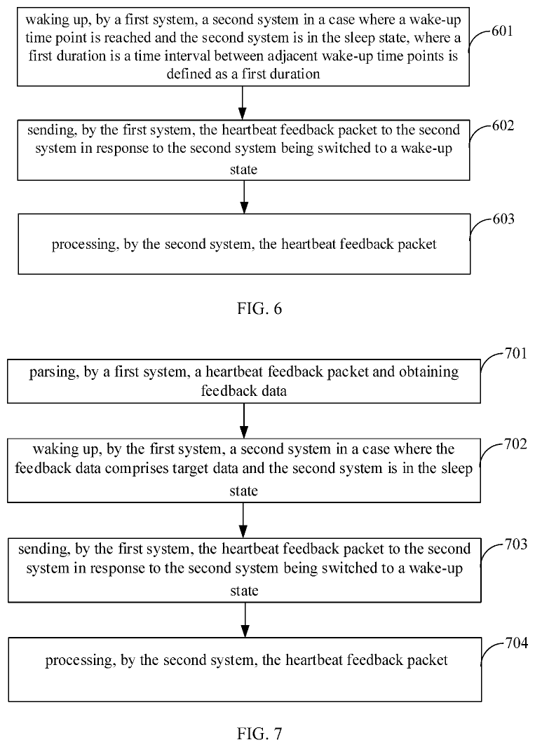

As illustrated in FIG. 7, FIG. 7 illustrates a flowchart of a process of waking up a second system according to another embodiment of the present disclosure. The method may include the following operations.

At block 701, the first system parses the heartbeat feedback packet and obtains feedback data.

The first system parses the heartbeat feedback packet and determines whether it is necessary to process the heartbeat feedback packet through the second system based on parsed feedback data.

In a possible embodiment, when a data wake-up condition is contained in the heartbeat packet sending request and the data wake-up condition indicates that when target data is contained in the feedback data, the second system is woken up for processing. Therefore, the first system is configured to detect whether the target data is contained in the feedback data. If the target data is contained in the feedback data, the first system perform the following operation 702. If the target data is not contained in the feedback data, the first system may continue to process the heartbeat feedback packet without the need for the second system to process the heartbeat feedback packet. In other possible embodiments, the data wake-up condition (the target data) may also be sent independently of the heartbeat packet sending request, which is not limited herein.

At block 702, when the target data is contained in the feedback data and the second system is in the sleep state, the first system wakes up the second system.

In an exemplary embodiment, when the vehicle state in the feedback data is the starting state, the first system determines that the data wake-up condition is met. When the vehicle state in the feedback data is the non-started state, the first system determines that the data wake-up condition is not met.

In some embodiments, the first system detects whether the second system is in the wake-up state. If the second system is in the wake-up state (the second system may be currently processing other events), the block 703 is performed. If the second system is in the sleep state, wake up the second system.

In some embodiments, the first system wakes up the second system by generating an interrupt.

At block 703, when the second system is switched to the wake-up state, the first system sends a heartbeat feedback packet to the second system.

In a possible embodiment, when the second system is in the wake-up state, the heartbeat feedback packet continues to be received by the first system, but the first system no longer processes the heartbeat feedback packet. Instead, the first system directly forwards the heartbeat feedback packet to the second system. The first system may forward the heartbeat feedback packet to the second system through the SPI, which is not limited herein.

It should be noted that when the second system is in the wake-up state, the first system continues to send the heartbeat packet based on the heartbeat packet sending request, so as to maintain the communication connection.

At block 704, the second system processes the heartbeat feedback packet.

The second system processes the heartbeat feedback packet sent by the first system. In a possible embodiment, the second system displays a processing result (the second system obtaining a screen control authority). Alternatively, the second system performs muting process on the heart-beat feedback packet in the background and sends the processing result to the first system for displaying (the first system has the screen control authority).

In an exemplary embodiment, the external device is the vehicle head unit, and the electronic device is the smartwatch. After receiving the heartbeat packet sent by the smartwatch, the vehicle head unit adds a vehicle state to the heartbeat feedback packet. When the first system detects that the vehicle state in the heartbeat feedback packet is in a staring state, the first system wakes up the second system in the sleep state. After the second system is woken up, the second system obtains the heartbeat feedback packet from the first system and displays vehicle information contained in the heartbeat feedback packet (such as vehicle speed, fuel consumption, door lock opening and closing status, air conditioning temperature, etc.).

Similar to the periodic wake-up manner, after the second system is woken up by the first system, the second system is switched from the wake-up state to the sleep state again after processing the heartbeat feedback packet, so as to reduce the increasing power consumption that results from the system being in the wake-up state for a long time.

In different scenarios, conditions for waking up the second system may vary. In some embodiments, when the external device is the vehicle head unit, the vehicle is in the non-started state, and the second system needs to be woken up when the vehicle starts. When the vehicle is in the starting state, the second system needs to be woken up when the vehicle is over-speed, the fuel level is too low, or the door is unlocked. Therefore, in a possible embodiment, when the processing of the heartbeat feedback packet is completed, the second system updates the data wake-up condition, and then is switched from the wake-up state to the sleep state.

In some embodiments, the second system determines a real-time state of the external device based on the feedback data in the heartbeat feedback packet, and thus the data wake-up condition may be updated based on the real-time state of the external device. The second system stores a corresponding relationship between a state of the external device and the data wake-up condition.

In some embodiments, when the data wake-up condition is contained in the heartbeat packet sending request, the second system sends a new heartbeat packet sending request to the first system before switching to the sleep state. The data wake-up condition in the new heartbeat packet sending request is different from the data wake-up condition in the previous heartbeat packet sending request. Correspondingly, the first system sends the heartbeat packet to the external device based on the new heartbeat packet sending request, and determines whether it is necessary to wake up the second system based on the new data wake-up condition.

Of course, in other possible embodiments, the conditions for waking up the second system may not vary. When the processing of the heartbeat feedback packet is completed, the second system switches from the wake-up state to the sleep state. Correspondingly, the first system continues to send the heartbeat packet to the external device based on the heartbeat packet sending request, and determines whether it is necessary to wake up the second system based on the original data wake-up condition.

It should be noted that when a data content of the heartbeat packet changes, the second system may send the new heartbeat packet sending request to the first system, such that the first system may generate the new heartbeat packet based on the new heartbeat packet sending request and send the new heartbeat packet, which is no repeated herein.

In addition, in the foregoing embodiments, only a single wake-up condition is taken as an example for exemplary description. In a practical application, two or more wake-up conditions may also be enabled at the same time. For example, the periodic wake-up condition and the data wake-up condition may be enabled at the same time, which is no repeated herein.

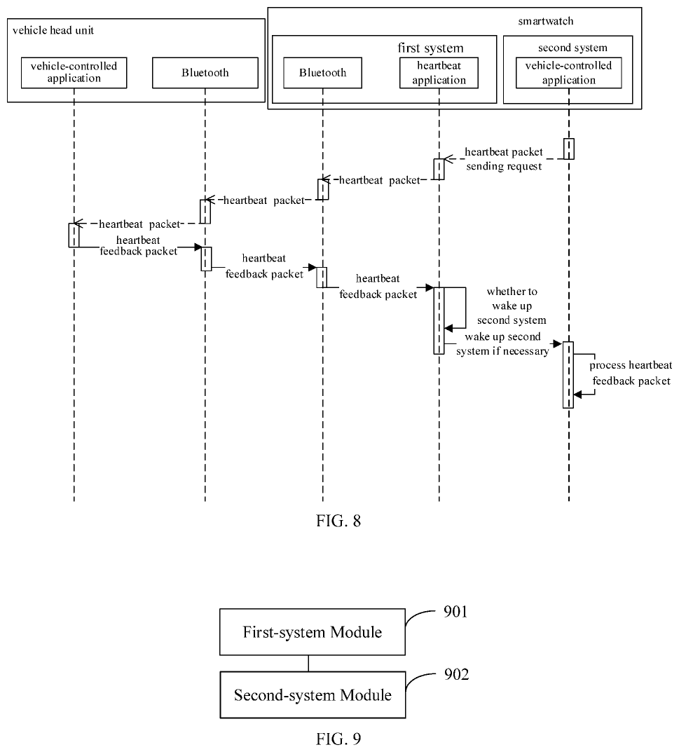

Exemplarily, as illustrated in FIG. 8, the vehicle-controlled application of the second system in the smartwatch sends the heartbeat packet sending request to the heartbeat application of the first system. The heartbeat application may periodically generate the heartbeat packet based on the setting of the heartbeat packet sending request, and the heartbeat packet is sent to the vehicle head unit through the Bluetooth. The vehicle-controlled application in the vehicle head unit generates the heartbeat feedback packet based on vehicle state information and sends the heartbeat feedback packet to the smartwatch through the Bluetooth. The heartbeat application of the first system parses the heartbeat feedback packet. When a parsing result meets the data wake-up condition for waking up the second system, or when the periodic wake-up condition is met, the first system wakes up the second system and activates the vehicle-controlled application, thereby processing the heartbeat feedback packet through the vehicle-controlled application.

As illustrated in FIG. 9, FIG. 9 illustrates a structural block diagram of an apparatus for maintaining a communication connection according to an embodiment of the present disclosure. The apparatus may be implemented as all or part of an electronic device by software, hardware, or a combination of both. The apparatus includes a first-system module 901 and a second-system module 902.

The second-system module 902 is configured to send a heartbeat packet sending request to a first-system module 901. The first-system module 901 is configured to send a heartbeat packet to an external device based on the heartbeat packet sending request, where the heartbeat packet is configured to maintain a communication connection between the electronic device and the external device. The first-system module 901 is further configured to receive a heartbeat feedback packet sent by the external device.

In some embodiments, the first-system module 901 is further configured to wake up the second system in a case where a wake-up condition is met and the second system is in a sleep state, where the wake-up condition is provided by the second-system module 902. The first-system module 901 is further configured to send the heartbeat feedback packet to the second system in response to the second system being switched to a wake-up state. The second-system module 902 is further configured to process the heartbeat feedback packet.

In some embodiments, the wake-up condition is a periodic wake-up condition. The first-system module 901 is further configured to wake up the second system in a case where a wake-up time point is reached and the second system is in the sleep state, wherein a time interval between adjacent wake-up time points is defined as a first duration.

In some embodiments, the second-system module 902 is further configured to update the periodic wake-up condition in response to a processing result of the heartbeat feedback packet meeting a condition for updating duration.

In some embodiments, the periodic wake-up condition is contained in the heartbeat packet sending request; or the periodic wake-up condition is sent independently of the heartbeat packet sending request.

In some embodiments, the wake-up condition is a data wake-up condition. The first-system module 901 is further configured to parse the heartbeat feedback packet and obtain feedback data, and is configured to wake up the second system in a case where the feedback data comprises target data and the second system is in the sleep state.

In some embodiments, the second-system module 902 is further configured to the data wake-up condition and switch from the wake-up state to the sleep state in response to processing of the heartbeat feedback packet being completed.

In some embodiments, the data wake-up condition is contained in the heartbeat packet sending request, or the data wake-up condition is sent independently of the heartbeat packet sending request.

In some embodiments, based on the heartbeat packet sending request, the first-system module 901 is further configured to send the heartbeat packet to the external device according to a heartbeat period.

In some embodiments, the first-system module 901 is further configured to disconnect the communication connection in a case where the heartbeat feedback packet sent by the external device is not received in a second duration, wherein the second duration is provided by the second system.

In some embodiments, operating power consumption of the first system is lower than that of the second system.

In conclusion, in some embodiments of the present disclosure, when the second system needs to maintain the communication connection with an external device, the second system sends a heartbeat packet sending request to the first system. The first system sends a heartbeat packet to the external device based on the heartbeat packet sending request, and receives a heartbeat feedback packet sent by the external device. When the second system is in a sleep state, or a process of an application program in the second system that needs to maintain data communication with the external device ends, a normal sending of the heartbeat packet is maintained between the electronic device and the external device, so as to ensure the availability of a communication connection between subsequent devices. In addition, when the second system is a high power consumption system, and the first system is a low power consumption system, the low power consumption system maintains the communication connection, and the second system may enter the sleep state, so as to facilitate reducing the power consumption of the electronic device and extending the battery life of electronic device.

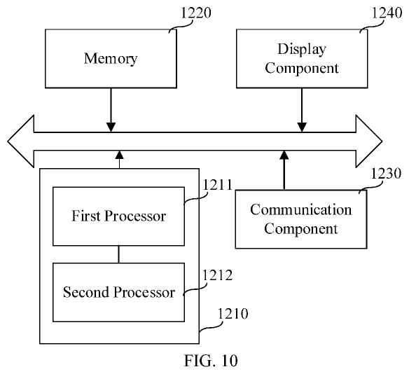

As illustrated in FIG. 10, FIG. 10 illustrates a structural block diagram of an electronic device according to an embodiment of the present disclosure. The electronic device in some embodiments of the present disclosure may include one or more of the following components: a processor 1210 and a memory 1220.

In some embodiments, the processor 1210 at least includes a first processor 1211 and a second processor 1212. The first processor 1211 is configured to run the first system, and the second processor 1212 is configured to run the second system. The first processor 1211 has power consumption lower than the second processor 1212, and the first processor 1211 has a performance lower than the second processor 1212. The processor 1210 is configured to connect to each part of the whole electronic device via various interfaces and lines, to execute various functions of the electronic device and process data by running or executing an instruction, a program, a code set, or an instruction set that are all stored in the memory 1220 and invoking data stored in the memory 1220. Optionally, the processor 1210 may be implemented by using at least one hardware form of a digital signal processing (DSP), a field-programmable gate array (FPGA), or a programmable logic array (PLA). The processor 1210 may integrate one or any combination of a CPU, a graphic processing unit (GPU), a neural-network processing unit (NPU), a modem, or the like. The CPU is mainly configured to process an operating system, a UI, an application program, or the like. The GPU is configured to render and draw content required to be displayed on the TP. The NPU is configured to realize an artificial intelligence (AI) function. The modem is configured to process wireless communication. It should be understood that the modem may also not be integrated into the processor 1210 and may be implemented via a chip separately.

The memory 1220 may include the RAM or the ROM. Optionally, the memory 1220 may include a non-transitory computer-readable storage medium. The memory 1220 is configured to store an instruction, a program, a code, a code set, or an instruction set. The memory 1220 may include a program storage area and a data storage area. The program storage area is configured to store instructions for implementing the operating system, instructions for implementing at least one function (such as a touch control function, a sound playing function, an image playing function, or the like), instructions for implementing the above embodiments, or the like. The data storage area is configured to store data (such as audio data, phonebooks, or the like) created according to the usage of the wearable device.

The electronic device in embodiments of the present disclosure further includes a communication component 1230 and a display component 1240. The communication component 1230 may be a Bluetooth component, a wireless fidelity (Wi-Fi) component, a near field communication (NFC) component, or the like, and is configured to communicate with an external device (a server or other terminal devices) via a wired network or a wireless network. The display component 1240 is configured to display the GUI and/or receive a user interaction operation.

In addition, those skilled in the art can understand that the structure of the electronic device illustrated in the foregoing figures does not constitute any limitation on the electronic device. The electronic device may include more or fewer components than illustrated or may combine certain components or have different configurations or arrangements of components. For example, the electronic device further includes components such as a radio frequency (RF) circuit, an input unit, a sensor, an audio circuit, a loudspeaker, a microphone, a power supply, or the like, which are not described herein again.

A computer-readable storage medium is further provided in embodiments of the present disclosure. The storage medium store at least one instruction, and the at least one instruction is configured to be executed by the processor to perform the method for maintaining communication connection as described in the foregoing embodiments.

A computer program product or computer program is further provided in embodiments of the present disclosure. The computer program product or computer program includes a computer instruction stored in a computer-readable storage medium. The computer instruction is configured to be read by the processor of the electronic device from the computer-readable storage medium, and the computer instruction, when executed by the processor, causes a terminal to perform the method for maintaining communication connection as described in the foregoing embodiments.

Those skilled in the art should understand that in one or more of the above embodiments, the functions described in embodiments of the present disclosure may be implemented by any one or any combination of a hardware, a software, or a firmware. When implemented by software, functions may be stored in the computer-readable medium or transmitted as one or more instructions or codes in the computer-readable medium. The computer-readable medium includes a computer storage medium and a communication medium. The communication medium includes any medium that facilitates the transfer of a computer program from one place to another place. The storage medium may be any available medium that can be accessed by a general-purpose computer or a special-purpose computer.

The above are only optional embodiments of the present disclosure and are not intended to limit the scope of protection of the present disclosure. any modification, equivalent arrangements, and improvement made within the spirit and principles of the present disclosure shall be included in the scope of protection of the present disclosure.

What is claimed:

1. A method for maintaining a communication connection, applicable into an electronic device, the electronic device supporting running of a first system and a second system, and the method comprising:
sending, by the first system, a heartbeat packet to an external device based on a heartbeat packet sending request, wherein the heartbeat packet is configured to maintain a communication connection between the electronic device and the external device; and
receiving, by the first system, a heartbeat feedback packet sent by the external device.

2. The method according to claim 1, further comprising:
waking up, by the first system, the second system in a case where a wake-up condition is met and the second system is in a sleep state.

3. The method according to claim 1, before sending, by the first system, the heartbeat packet to an external device based on the heartbeat packet sending request, the method further comprises:
sending, by the second system, the heartbeat packet sending request to the first system.

4. The method according to claim 2, wherein
sending, by the first system, the heartbeat feedback packet to the second system in response to the second system being switched to a wake-up state; and
processing, by the second system, the heartbeat feedback packet.

5. The method according to claim 4, wherein
processing, by the second system, the heartbeat feedback packet, comprises:
displaying, by the second system, a processing result; or
performing muting process, by the second system, on the heartbeat feedback packet in a background and sending a processing result to the first system for displaying.

6. The method according to claim 2, wherein the wake-up condition is a periodic wake-up condition; and
waking up, by the first system, the second system in a case where the wake-up condition is met and the second system is in the sleep state, comprises:
waking up, by the first system, the second system in a case where a wake-up time point is reached and the second system is in the sleep state, wherein a time interval between adjacent wake-up time points is defined as a first duration.

7. The method according to claim 6, further comprising:
updating, by the second system, the periodic wake-up condition, in response to a processing result of the heartbeat feedback packet meeting a condition for updating duration.

8. The method according to claim 2, wherein the wake-up condition is a data wake-up condition; and
waking up, by the first system, the second system in a case where the wake-up condition is met and the second system is in the sleep state, comprises:
parsing, by the first system, the heartbeat feedback packet and obtaining feedback data; and
waking up, by the first system, the second system in a case where the feedback data comprises
target data and the second system is in the sleep state.

9. The method according to claim 8, further comprising:
updating, by the second system, the data wake-up condition and switching from the wake-up state to the sleep state in response to processing of the heartbeat feedback packet being completed; and/or,
determining, by the second system, a real-time state of the external device based on the feedback data; and
updating, by the second system, data wake-up condition based on the real-time state of the external device.

10. The method according to claim 8, further comprising:
in response to the data wake-up condition being contained in the heartbeat packet sending request, sending, by the second system, a new heartbeat packet sending request to the first system before switching to the sleep state;
wherein a data wake-up condition in the new heartbeat packet sending request is different from a data wake-up condition in a previous heartbeat packet sending request.

11. The method according to claim 2, wherein the wake-up condition is provided by the second system, wherein wake-up condition is contained in the heartbeat packet sending request or is sent independently of the heartbeat packet sending request.

12. The method according to claim 1, further comprising:
disconnecting, by the first system, the communication connection in a case where the heart-beat feedback packet sent by the external device is not received in a second duration, wherein the second duration is provided by the second system.

13. The method according to claim 1, wherein operating power consumption of the first system is lower than that of the second system.

14. The method according to claim 8, wherein external device is a vehicle head unit,
waking up, by the first system, the second system in a case where the feedback data comprises target data and the second system is in the sleep state, comprises:
in a case where the vehicle is in starting state, waking up, by the first system, the second system in the sleep state in response to detecting that the vehicle is over-speed, the fuel level is too low, or the door is unlocked; and/or,
in a case where the vehicle is in the non-started state, waking up, by the first system, the second system in the sleep state in response to detecting that a vehicle state in the heartbeat feedback packet is in a staring state; and/or,
waking up, by the first system, the second system in a sleep state in response to detecting that a vehicle state in the heartbeat feedback packet is in a staring state.

15. The method according to claim 4, processing, by the second system, the heartbeat feedback packet obtaining, by the second system, the heartbeat feedback packet from the first system and displaying vehicle information contained in the heartbeat feedback packet.

16. The method according to claim 1, the method further comprises:
switching the second system from a wake-up state to the sleep state again after a duration for which the second system remains the wake-up state reaches a preset duration.

17. The method according to claim 3, wherein sending, by the second system, the heartbeat packet sending request to the first system, comprises:
determining, by the second system, a condition for reducing duration is met in a case where it is detected that a value of an identification bit corresponding to the vehicle state is 1 and the second system is in a wake-up state;
sending, by the second system, the second heartbeat packet sending request to the first system.

18. The method according to claim 3, wherein, the heartbeat feedback packet based on vehicle state information;
sending, by the second system, the heartbeat packet sending request to the first system, comprises:
sending, by the vehicle-controlled application of the second system, the heartbeat packet sending request to the heartbeat application of the first system;
periodically generating, by the heartbeat application of the first system, the heartbeat packet based on the setting of the heartbeat packet sending request;
sending, by the heartbeat application of the first system, the heartbeat packet to a vehicle head unit through Bluetooth.

19. An electronic device, comprising a processor and a memory, the memory storing at least one instruction, and the at least one instruction being configured to be executed by the processor to perform:
sending, by the first system, a heartbeat packet to an external device based on the heartbeat packet sending request, wherein the heartbeat packet is configured to maintain a communication connection between the electronic device and the external device; and
receiving, by the first system, a heartbeat feedback packet sent by the external device.

20. A non-transitory computer-readable storage medium, the storage medium storing at least one instruction, the at least one instruction being configured to be executed by a processor to perform:
sending, by the first system, a heartbeat packet to an external device based on the heartbeat packet sending request, wherein the heartbeat packet is configured to maintain a communication connection between the electronic device and the external device; and
receiving, by the first system, a heartbeat feedback packet sent by the external device.
